(19) United States
(12) Patent Application Publication
(10) Pub. No.: US 2008/0185421 A1
(43) Pub. Date: Aug. 7, 2008

(54) Process for reflow soldering

(75) Inventors: Rolf Ludwig Diehm, Wertheim (DE); Markus Walter, Wertheim (DE); Horst Lettner, Aschaffenburg (DE)

Correspondence Address: BIRCH STEWART KOLASCH & BIRCH, PO BOX 747, FALLS CHURCH, VA, 22040-0747, US

(73) Assignee: SEHO Systemtechnik GmbH, Kreuzwertheim (DE)

(21) Appl. No.: 12/010,105

(22) Filed: Jan. 18, 2008

(30) Foreign Application Priority Data
Feb. 2, 2007 (DE) 10 2007 005 345.4

(51) Int. Cl. B23K 1/00

(52) U.S. Cl. 228/176; 228/18

(57) ABSTRACT

The invention relates to a process for the reflow soldering of printed circuit board assemblies provided with solder paste in a sealed chamber with heating in the chamber. In a first process step, the pressure in the chamber is amplified in comparison with the atmospheric pressure and the temperature in the chamber is increased by convection heating to melt the solder paste and, in a second process step, the pressure is again lowered to atmospheric pressure in controlled manner while maintaining the temperature.

The invention relates to a process for the reflow soldering of printed circuit board assemblies provided with solder paste in a sealed chamber with heating in the chamber.

During reflow soldering, the solder joints occasionally develop so-called voids, which, on the one hand, reduce the electrically effective cross-section of the affected solder joint and, on the other hand, harbour the risk of the solder joint breaking apart. In any event, also on account of poorer dissipation of heat loss from the printed circuit board assemblies, such voids represent a threat to the affected printed circuit board assembly, with the consequence that consideration has already been given to the elimination of voids still during the soldering process. The procedure adopted to date has been such that the printed circuit board assemblies, which are completed by reflow soldering, are during the soldering process subjected in a chamber sealed by air locks to a vacuum or substantial negative pressure, this effectively extracting from the void the gas contained therein, whereupon the void bursts, thereby giving rise to an uninterrupted soldered joint.

In a continuous fabrication process, such an evacuation operation takes a considerable amount of time, because the vacuum required for the respective purpose cannot be produced instantly. It in any event necessitates a complex outpumping operation which cannot be carried out at high speed and which normally, as experience shows, lasts several seconds. Furthermore, the evacuation of the sealed chamber does not allow the use of all conventional heating methods, because convection heating must at any rate be discounted because of the vacuum. In connection with the elimination of voids by evacuation, therefore, the increase in temperature in the chamber is usually accomplished in a vapour phase through condensation of an inert liquid with a boiling point slightly higher than the melting point of the solder. As an example of this prior art, reference is made to DE 102 37 494 A1. The same process is described in DE 199 11 887 C1.

The object of the invention is to counteract voids in solder joints of reflow-soldered printed circuit board assemblies such that, on the one hand, this necessitates only a small degree of technical complexity and, on the other hand, the elimination of any existing voids can be achieved with particular rapidity. The object of the invention is achieved in that, in a first process step, the pressure in the chamber is amplified in comparison with the atmospheric pressure and the temperature in the chamber is increased by convection heating to melt the solder paste and, in a second process step, the pressure is again lowered to atmospheric pressure in controlled manner while maintaining the temperature.

The operations that are combined in the first process step, namely those of amplifying the pressure in the chamber and of increasing the temperature in the chamber by convection heating, can be accomplished using relatively simple technical means. Available means for increasing the pressure include, for example, low-cost pressurized-gas bottles, the gas from which, more particularly air, can be introduced into the chamber at high pressure. Nor does decisive importance attach to the especially secure sealing of the chamber, because, with this process, it can readily be accepted that some of the gas from the pressurized-gas bottle will escape through leaks in the air locks surrounding the chamber. By contrast, when a vacuum is being produced, any leak at the air locks will lead to a considerable delay in pumping the gas out of the chamber. Consequently, the air locks, which seal the chamber, are rendered considerably more simple from a technical viewpoint if the pressure in the chamber is amplified. Furthermore, pressure amplification also allows the use in the chamber of especially advantageous convection heating, since the therefor required gas is available in the chamber, said gas being able easily to reach all the parts of a printed circuit board assembly by being circulated. When the atmospheric pressure is lowered while the temperature in the chamber is maintained, a positive pressure is then created in the interior of any existing voids, said positive pressure originating from the previous increase of pressure, with the consequence that, faced with the lowered pressure in the chamber, the voids burst open to release the therein contained gas, the temperature in the chamber being maintained above the melting point of the solder paste and the opened voids disappearing.

The process according to the invention, therefore, represents a fundamental departure from the known process of employing a vacuum, this fact being also confirmed in that, already in the first process step, in which the temperature in the chamber is increased by convection heating to melt the solder paste, the pressure in the chamber is amplified in comparison with the atmospheric pressure, as a consequence of which, therefore, with the solder melted, a positive pressure with respect to the atmospheric pressure is built up in any existing voids. Said positive pressure does not then escape until during the second process step, when the pressure in the chamber is lowered while the temperature of the solder is maintained, so that said solder, in the melted state, is able to allow any existing positive pressure in the voids to escape. Said escape of positive pressure takes place immediately upon the melting of the solder, this fact likewise illustrating the difference between the known process and the process according to the invention.

The effect of the variation of pressure on any existing voids can be advantageously intensified in that an alternating pressure variation is superimposed either on the pressure amplification or on the pressure lowering. Alternatively, it is possible for said alternating pressure variation to be superimposed not only in the one direction, namely either pressure amplification or pressure lowering, but in both directions, i.e. it is possible, within the process according to the invention, for the alternating pressure variation during soldering to be superimposed both on the pressure amplification and also on the pressure lowering, the ensuing pulsation making it easier for any voids to burst and release the therein contained gas, as a consequence of which the voids can with certainty be made entirely to disappear.

Illustrative embodiments of the invention are presented in the drawings, in which:

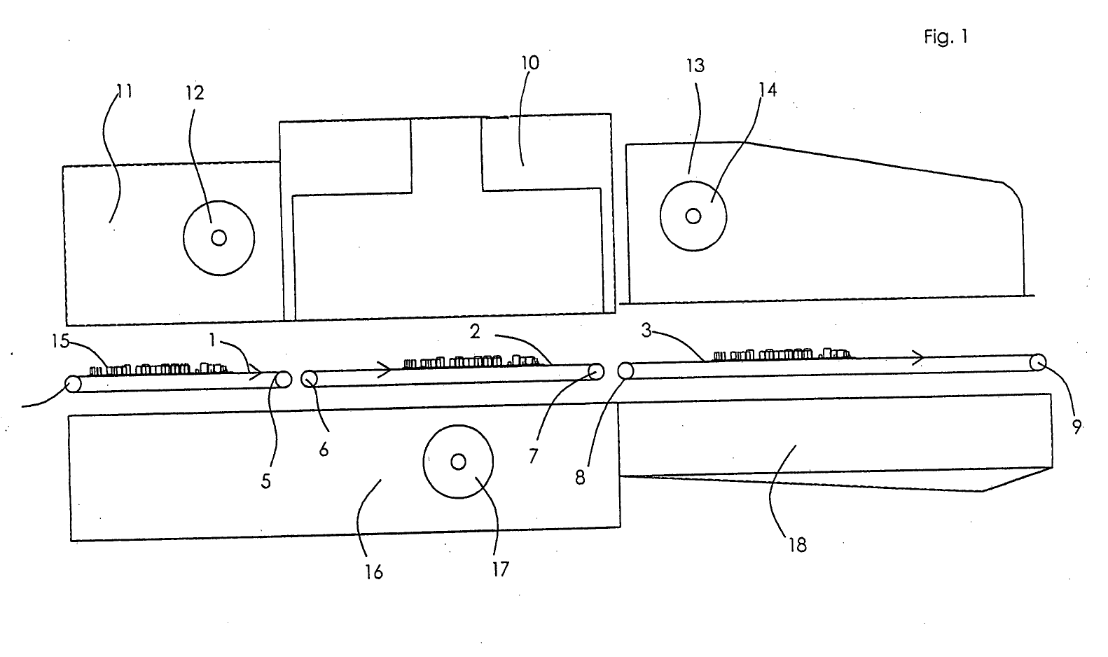

FIG. 1 shows a device for reflow soldering with a middle soldering stage for treating the printed circuit board assemblies under positive pressure;

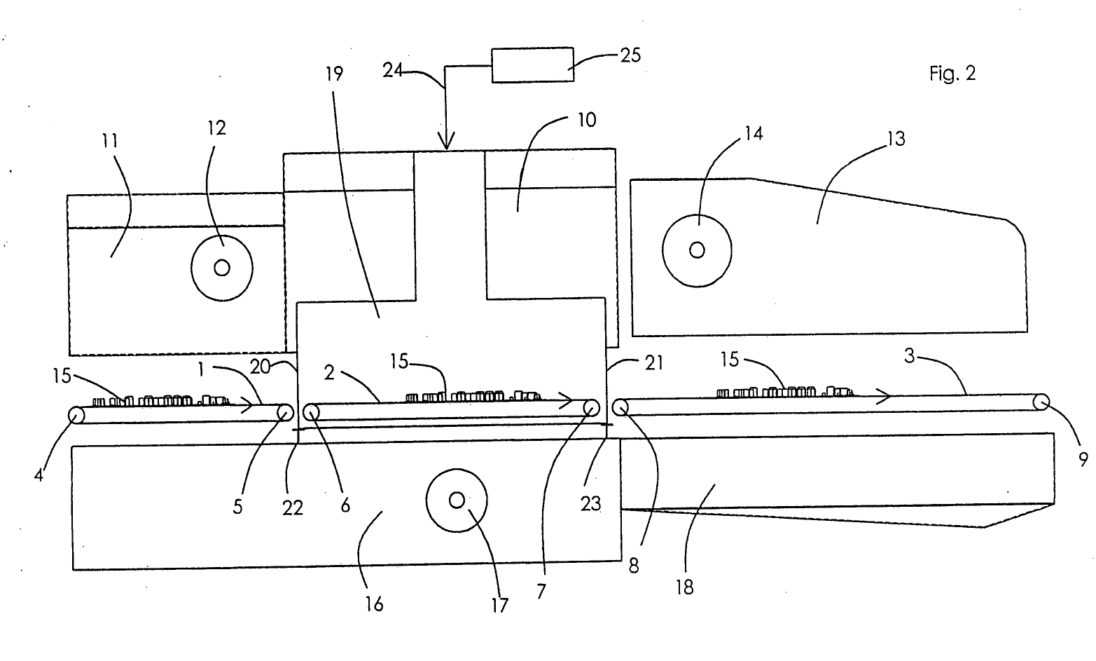

FIG. 2 shows the same device with a design of the middle soldering stage for the lowering and raising of a pressure housing;

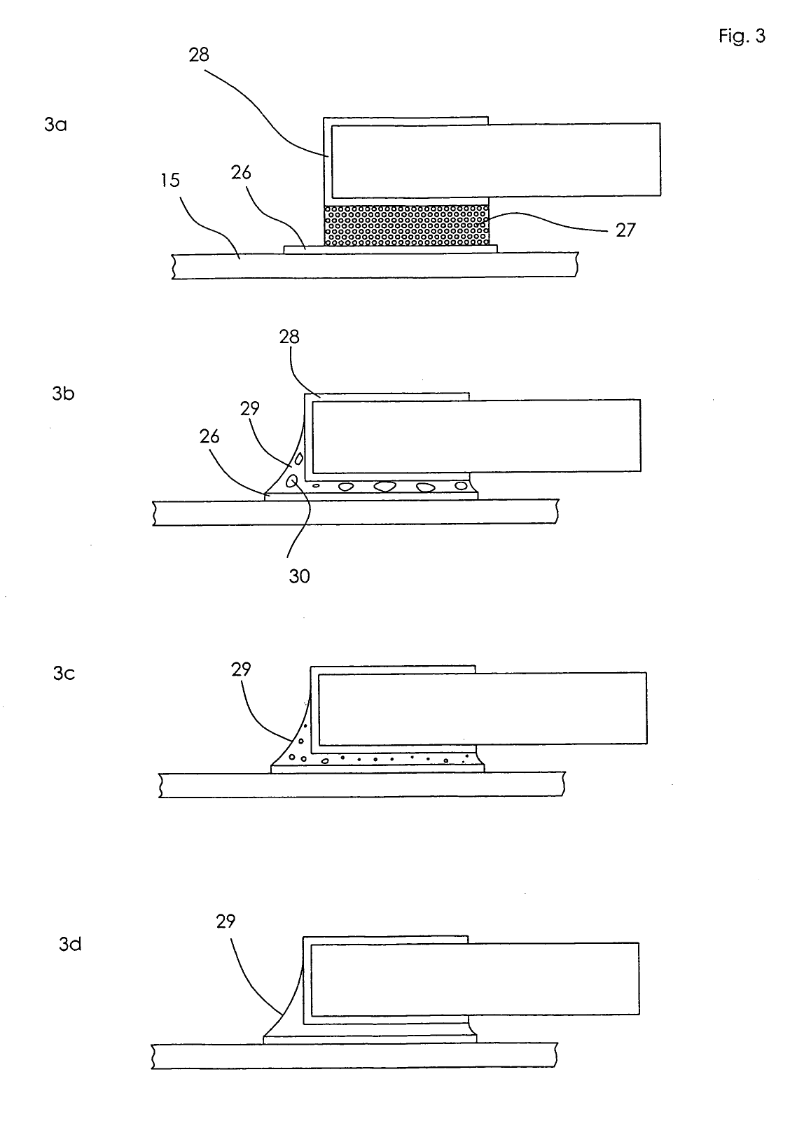

FIGS. 3a, b, c, d show the individual phases of melting of the solder and elimination of voids from the solder joints, wherein

FIG. 3a shows the solder joint, provided with solder paste, in the unsoldered state;

FIG. 3b shows the voids-containing melted solder joint;

FIG. 3c shows the same solder joint under the effect of the positive pressure with the voids greatly reduced in size;

FIG. 3d shows the same solder joint without voids;

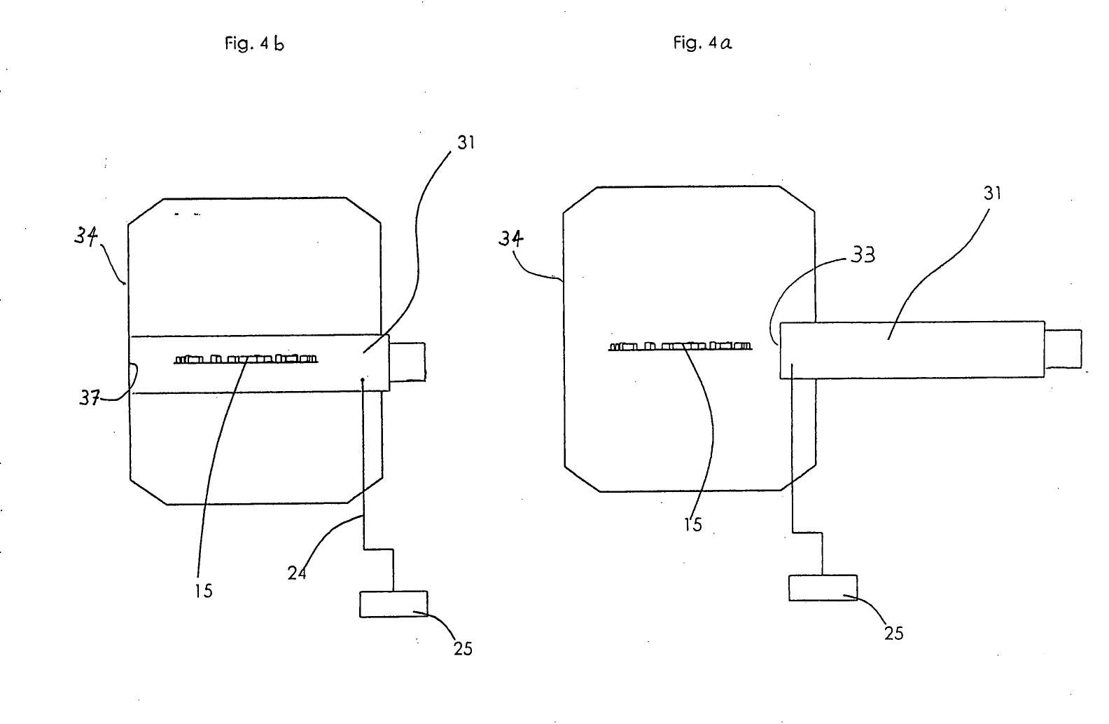

FIGS. 4a, b show a side elevation view of the middle stage with the pressure housing being inserted and withdrawn from the side.

The device presented in FIG. 1 for the reflow soldering of printed circuit board assemblies 15 contains as its transport mechanism a plurality of successive conveyor belts 1, 2 and 3 which can, if required, be supplemented at either end by additional individual conveyor belts. The conveyor belts in question are chain-link belts of known type which are looped around drive rollers 4, 5, 6, 7, 8 and 9 and which are driven by said drive rollers in the direction indicated by the arrows. Situated in the middle of the device is the soldering stage 10, the mode of operation of which will be more fully discussed hereinbelow. Positioned before the soldering stage 10 is the heating stage 11, which can be heated in known manner to melt the solder joints, for example by means of a heater blower 12. Positioned after the soldering stage 10 is the cooling stage 13, which is likewise provided with a blower 14 for supplying cool air to the printed circuit board assemblies 15. FIG. 1 shows a plurality of printed circuit board assemblies 15 on the conveyor belts 1, 2 and 3, this being intended to indicate that the device is basically designed for continuous operation. Arranged below the conveyor belts 1, 2 and 3 are the bottom case 16 with the heater blower 17 and the cooling case 18.

The above-described device is basically a known arrangement of the kind presented and explained in DE 10 2004 017 772 A1.

FIG. 2 presents the device from FIG. 1 in the working position, in which the pressure housing 19 has been lowered in the soldering stage 10 and abuts with its walls 20 and 21 against the sealing counter-bearings 22 and 23 below the conveyor belt 2. The conveyor belt 2 is thus situated in a sealed chamber which is supplied via the pressurized-gas line 24 with pressurized gas which is pumped by the pump 25 into the pressurized-gas line 24, there being produced in the chamber formed by the interior of the pressure housing 19 a pressure which is higher than the atmospheric pressure and which also has an effect on the printed circuit board assembly 15 (which is provided with solder paste) in the manner presented with reference to FIGS. 3a-3d, which will be more fully discussed hereinbelow. The solder paste at the solder joints of the printed circuit board assembly 15 has been melted and includes any voids that may have been created.

After soldering has taken place, the pressure in the pressure housing 19 is again lowered to atmospheric pressure and the printed circuit board assembly 15 is conveyed onwards from conveyor belt 2 to conveyor belt 3, where it is then cooled through the action of the cooling blower 14 and the cooling case 18, this completing the processing of the respective printed circuit board assembly, including soldering.

The above-mentioned operation of the soldering of the printed circuit board assembly 15 inside the pressure housing 19 involves the processing phases that are presented below with reference to FIGS. 3a to 3d. In FIG. 3a, the printed circuit board assembly 15 has been positioned via the conductor 26 on the printed circuit board 15, which represents the printed circuit board assemblies 15 transported by conveyor belts 1 to 3. Applied to the conductor 26 is the solder paste 27, which extends as far as the component 28 to be soldered. The operation presented hereinabove in connection with FIG. 2 results in the connection between conductor 26 and component 28 as presented in FIG. 3b, wherein the solder zone 29 presented in FIG. 3b includes the voids 30. The positive pressure in the pressure housing 19 greatly reduces the size of the voids, as shown in FIG. 3c, but the voids still contain the pressurized gas in their interiors. When the pressure is then removed from the pressure housing 19 and atmospheric pressure returns to the pressure housing 19, the remaining voids in the solder zone 29 burst to produce a continuous, void-free solder zone, as presented in FIG. 3 d.

FIG. 4a presents a device which is basically capable of interaction with the device from FIG. 1. In FIG. 4a, however, the soldering stage is of a design different from that presented in FIG. 1, being namely in the form of a pressure housing 31 that is movable transversely to the direction of movement of conveyor belts 1, 2 and 3. FIG. 4b presents the pressure housing 31 in the working position, in which it has been slid from the side over the conveyor belt 1 (15 in FIG. 2) to enclose said conveyor belt 1, as shown in FIG. 2, this resulting, as in the case of the pressure housing 19 in FIG. 2, in the formation of an enclosed heating and pressure space into which pressurized gas is pumped by the pump 25 and in which the soldering operation then takes place, the pressure housing 31 creating a seal with its front end 33 against the wall of the housing 34 to form a sealed chamber. The arrangement according to FIGS. 4a and b, therefore, merely represents a variation with regard to the design and movement of the pressure housing 19, this being intended to indicate that the process according to the invention for melting the solder paste under increased pressure, followed by a reduction of the pressure in the pressure housing, can take place in identical manner in either case.

1. Process for the reflow soldering of printed circuit board assemblies (15) provided with solder paste in a sealed chamber with heating in the chamber (19), characterized in that, in a first process step, the pressure in the chamber (19) is amplified in comparison with the atmospheric pressure and the temperature in the chamber (19) is increased by convection heating to melt the solder paste and, in a second process step, the pressure is again lowered to atmospheric pressure in controlled manner while maintaining the temperature.

2. Process for reflow soldering according to claim 1, characterized in that an alternating pressure variation is superimposed on the pressure amplification.

3. Process for reflow soldering according to claim 1, characterized in that an alternating pressure variation is superimposed on the pressure lowering.

4. Process for reflow soldering according to claim 1, characterized in that an alternating pressure variation is superimposed both on the pressure amplification and also on the pressure lowering.

5. Device for implementing the process according to claim 1, characterized in that the chamber is formed by a pressure housing (19, 31), wherein said pressure housing (19, 31) is adapted to be brought by displacement into a position enclosing a printed circuit board assembly (15) and is connected to a pressurized-gas line (24, 32).

6. Process for reflow soldering according to claim 2, characterized in that an alternating pressure variation is superimposed on the pressure amplification.

7. Process for reflow soldering according to claim 3, characterized in that an alternating pressure variation is superimposed on the pressure lowering.

8. Process for reflow soldering according to claim 4, characterized in that an alternating pressure variation is superimposed both on the pressure amplification and also on the pressure lowering.
